(19) United States
(12) Patent Application Publication
(10) Pub. No.: US 2024/0005080 A1
(43) Pub. Date: Jan. 4, 2024

(54) DUMMY METAL FILL DESIGN FOR PARASITIC CAPACITANCE REDUCTION

(71) Applicant: International Business Machines Corporation, Armonk, NY (US)

(72) Inventors: LOUIS ZUOGUANG LIU, Schenectady, NY (US); Nianzheng Cao, Mohegan Lake, NY (US); Sae Kyu Lee, Cambridge, MA (US); Zhibin Ren, Hopewell Junction, NY (US)

(21) Appl. No.: 17/809,600

(22) Filed: Jun. 29, 2022

(51) Int. Cl. G06F 30/398; G06F 30/392

(52) U.S. Cl. CPC G06F 30/398; G06F 30/392; G06F 2111/20

(57) ABSTRACT

Aspects of the invention include systems and methods configured to provide parasitic capacitance-aware dummy metal fill methodologies. A non-limiting example computer-implemented method includes selecting one or more layers in a circuit design layout for interlayer parasitic capacitance reduction. One or more dummy metal shapes in each of the one or more layers selected for interlayer parasitic capacitance reduction is adjusted (e.g., trimmed, moved, and/or reshaped). One or more adjusted dummy metal shapes are modified until the circuit design layout satisfies design rule checking (DRC) analysis and timing is closed.

### BACKGROUND

The present invention generally relates to circuit design. More specifically, the present invention relates to a dummy metal fill designs in very large-scale integration (VLSI) circuits that reduce parasitic capacitance.

Conventional integrated circuits (ICs) are created by patterning a wafer or substrate to form various devices and interconnections. The process for designing an IC begins generally by hierarchically defining functional components of the circuit using a hardware description language. From this high-level functional description, a physical circuit implementation dataset known as a netlist is created. In its simplest form, a netlist identifies logic cell instances from a cell library and consists of a list of the electronic components in a circuit and a list of the nodes they are connected to (i.e., cell-to-cell connectivity information).

A layout file is created using the netlist in a process known as placing and routing (PnR). The layout file assigns (i.e., places) logic cells to physical locations in the device layout and a software “router” or circuit designer routes their interconnections. In this manner, component devices and interconnections of the integrated circuit are constructed layer by layer. Once the layout file is generated, each layer is successively deposited onto the wafer and patterned using a photolithography process. These processes leverage one or more photomasks to transfer a layout pattern onto a physical layer on the wafer. Each photomask is created from the layout file of each wafer layer.

Deep sub-micron technologies have complicated metal density rules required for manufacturing reliability. These rules include minimum, maximum, and density gradient checks. Metal density rules can be applied to the entire chip, on a stepped window, or in certain special circumstances, such as directly under C4 bumps. To pass density rules, chip designs first implement the base metal design, and then backfill empty spaces with so-called dummy metal shapes to provide the necessary density.

### SUMMARY

Embodiments of the present invention are directed to providing parasitic capacitance-aware dummy metal fill methodologies. A non-limiting example method includes selecting one or more layers in a circuit design layout for interlayer parasitic capacitance reduction. One or more dummy metal shapes in each of the one or more layers selected for interlayer parasitic capacitance reduction is adjusted (e.g., trimmed, moved, reshaped, etc.). One or more adjusted dummy metal shapes are modified until the circuit design layout satisfies design rule checking (DRC) analysis and timing is closed.

Other embodiments of the present invention implement features of the above-described method in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computer system for use in conjunction with one or more embodiments of the present invention;

FIG. 2 is a block diagram of a system configured to perform parasitic capacitance-aware dummy metal fill methodologies in accordance with one or more embodiments of the present invention;

FIG. 3 is a process flow of a method of fabricating an integrated circuit in accordance with one or more embodiments of the present invention;

FIG. 4 is a block diagram of a method of creating a physical layout of a circuit design in a manner that reduces interlayer parasitic capacitance in accordance with one or more embodiments of the present invention;

FIG. 5 is a design layout having a reduced interlayer parasitic capacitance in accordance with one or more embodiments of the present invention;

FIG. 6A is a design layout prior to dummy shape trimming in accordance with one or more embodiments of the present invention;

FIG. 6B is the design layout of FIG. 6A after trimming dummy shapes in accordance with one or more embodiments of the present invention;

FIG. 7 is a flowchart in accordance with one or more embodiments of the present invention;

FIG. 8 depicts a cloud computing environment according to one or more embodiments of the present invention; and

FIG. 9 depicts abstraction model layers according to one or more embodiments of the present invention.

### DETAILED DESCRIPTION

The design of next-generation integrated circuits (ICs) (e.g., those having very large-scale integration (VLSI) layouts) includes manufacturing layout verification, layout modifications, and verification of design conventions. Layout verification involves checking a proposed layout against design rules (DRC) and a comparison of extracted circuitry against a schematic netlist, often using electronic design automation (EDA) tools. To complete layout verification, a layout file is created using a netlist in a process known as placing and routing. The layout file assigns (i.e., places) logic cells to physical locations in the device layout and a software “router” or circuit designer routes their interconnections. Once the layout file is generated, each layer is successively deposited onto a wafer and patterned using a photolithography process.

IC feature geometries are continually being driven to smaller and smaller dimensions. For deep sub-micron manufacturing, such as below the 10 nm node, the layout geometries must satisfy increasingly complicated metal density rules to ensure manufacturing reliability. Simultaneously, as feature geometries continue scaling (for vias, wires, etc.) metal level thickness has also decreased. This result is somewhat forced, because as via critical dimension (CD) shrinks, resistance increases, which is compensated by reducing layer thickness. The end result is an increase in parasitic capacitance, especially manifested by timing/performance degradation after completing the dummy metal fill in the design.

There are two primary drivers for parasitic capacitance in a layout design: intra-layer parasitic capacitance and inter-layer parasitic capacitance. Intra-layer parasitic capacitance refers to parasitic capacitance between metal shapes in the same layer (i.e., originating from the sides). Inter-layer parasitic capacitance refers to parasitic capacitance between two vertically neighboring layers of metal in the design (i.e., originating from the top and bottom).

For prior technology nodes (i.e., above the 10 nm node), inter-layer parasitic capacitance was relatively small, and the effect of satisfying density requirements (i.e., placing and sizing dummy metal shapes) on inter-layer parasitic capacitance was not recognized as a design consideration. Inter-layer parasitic capacitance has become increasingly significant, however, as the distance between adjacent layers continues to scale (i.e., shrink). When a dummy metal shape is added into a design after placing and routing (post PnR), inter-layer parasitic capacitance increases as a function of overlap between the added dummy fill shape and the original nets. Unfortunately, current routing tools do not evaluate the effect that placing metal fill shapes can have on the total parasitic capacitance in a design. The result is power-inefficient chips which suffer from increasingly large timing discrepancies.

One or more embodiments of the present invention address one or more of the above-described shortcomings by providing parasitic capacitance-aware dummy metal fill methodologies. Embodiments of the present invention leverage a new physical design (PD) flow partition that reduces inter-layer parasitic capacitance caused due to the placement of dummy metal shapes post PnR.

In some embodiments of the invention, one or more parasitic capacitance-sensitive metal layers (i.e., one or more Mₓ layers) are identified and, for each of those layers, one or more dummy fill shapes are modified (e.g., trimmed and/or moved) to avoid or mitigate vertical overlap with active metal shapes in the layers above or below (e.g., logic cells in either or both of Mₓ₋₁ and Mₓ₊₁). The selection of capacitive-sensitive layers is discussed in greater detail herein, but can be based on, for example, empirical or modeled interlayer capacitance effects (e.g., a list of known sensitive layers from prior empirical data or simulations) and technology or design definitions (e.g., all layers at or below Mₐ).

Advantageously, leveraging a new PD flow partition to reduce inter-layer parasitic capacitance offers several technical benefits and solutions over conventional design schemes. For example, the proposed flow improves timing closure and offers real dynamic power reductions. Moreover, these benefits only improve as scaling continues to even thinner metal layers.

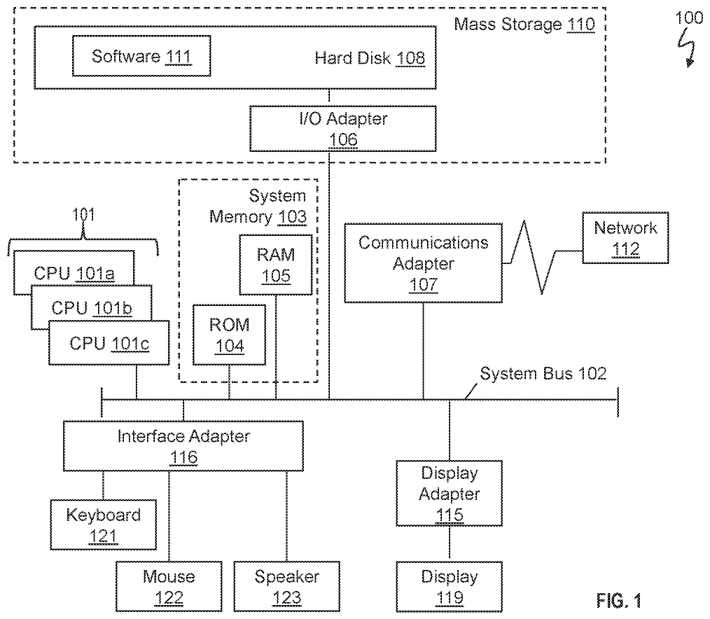

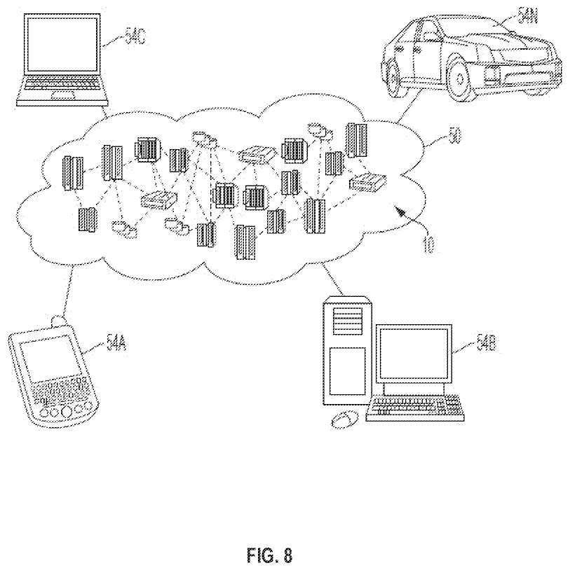

Turning now to FIG. 1, a computer system 100 is generally shown in accordance with one or more embodiments of the invention. The computer system 100 can be an electronic, computer framework comprising and/or employing any number and combination of computing devices and networks utilizing various communication technologies, as described herein. The computer system 100 can be scalable, extensible, and modular, with the ability to change to different services or reconfigure some features independently of others. The computer system 100 may be, for example, a server, desktop computer, laptop computer, tablet computer, or smartphone. In some examples, computer system 100 may be a cloud computing node (e.g., a node 10 of FIG. 8 below). Computer system 100 may be described in the general context of computer system executable instructions, such as program modules, being executed by a computer system. Generally, program modules may include routines, programs, objects, components, logic, data structures, and so on that perform particular tasks or implement particular abstract data types. Computer system 100 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, the computer system 100 has one or more central processing units (CPU(s)) 101a, 101b, 101c, etc., (collectively or generically referred to as processor(s) 101). The processors 101 can be a single-core processor, multi-core processor, computing cluster, or any number of other configurations. The processors 101, also referred to as processing circuits, are coupled via a system bus 102 to a system memory 103 and various other components. The system memory 103 can include a read only memory (ROM) 104 and a random-access memory (RAM) 105. The ROM 104 is coupled to the system bus 102 and may include a basic input/output system (BIOS) or its successors like Unified Extensible Firmware Interface (UEFI), which controls certain basic functions of the computer system 100. The RAM is read-write memory coupled to the system bus 102 for use by the processors 101. The system memory 103 provides temporary memory space for operations of said instructions during operation. The system memory 103 can include random access memory (RAM), read only memory, flash memory, or any other suitable memory systems.

The computer system 100 comprises an input/output (I/O) adapter 106 and a communications adapter 107 coupled to the system bus 102. The I/O adapter 106 may be a small computer system interface (SCSI) adapter that communicates with a hard disk 108 and/or any other similar component. The I/O adapter 106 and the hard disk 108 are collectively referred to herein as a mass storage 110.

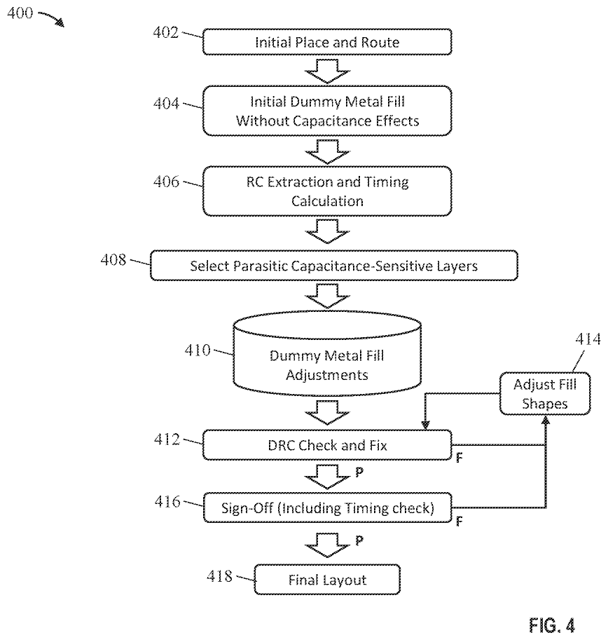

Software 111 for execution on the computer system 100 may be stored in the mass storage 110. Software 111 can include instructions needed direct the processor(s) 101 to complete any aspect of a parasitic capacitance-aware dummy metal fill process according to one or more embodiments, such as discussed with respect to FIGS. 4, 5, 6A, 6B, and 7.

The mass storage 110 is an example of a tangible storage medium readable by the processors 101, where the software 111 is stored as instructions for execution by the processors 101 to cause the computer system 100 to operate, such as is described herein below with respect to the various Figures. Examples of computer program product and the execution of such instruction is discussed herein in more detail. The communications adapter 107 interconnects the system bus 102 with a network 112, which may be an outside network, enabling the computer system 100 to communicate with other such systems. In one embodiment, a portion of the system memory 103 and the mass storage 110 collectively store an operating system, which may be any appropriate operating system to coordinate the functions of the various components shown in FIG. 1.

Additional input/output devices are shown as connected to the system bus 102 via a display adapter 115 and an interface adapter 116. In one embodiment, the adapters 106, 107, 115, and 116 may be connected to one or more I/O buses that are connected to the system bus 102 via an intermediate bus bridge (not shown). A display 119 (e.g., a screen or a display monitor) is connected to the system bus 102 by the display adapter 115, which may include a graphics controller to improve the performance of graphics intensive applications and a video controller. A keyboard 121, a mouse 122, a speaker 123, etc., can be interconnected to the system bus 102 via the interface adapter 116, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI) and the Peripheral Component Interconnect Express (PCIe). Thus, as configured in FIG. 1, the computer system 100 includes processing capability in the form of the processors 101, and, storage capability including the system memory 103 and the mass storage 110, input means such as the keyboard 121 and the mouse 122, and output capability including the speaker 123 and the display 119.

In some embodiments, the communications adapter 107 can transmit data using any suitable interface or protocol, such as the internet small computer system interface, among others. The network 112 may be a cellular network, a radio network, a wide area network (WAN), a local area network (LAN), or the Internet, among others. An external computing device may connect to the computer system 100 through the network 112. In some examples, an external computing device may be an external webserver or a cloud computing node.

It is to be understood that the block diagram of FIG. 1 is not intended to indicate that the computer system 100 is to include all of the components shown in FIG. 1. Rather, the computer system 100 can include any appropriate fewer or additional components not illustrated in FIG. 1 (e.g., additional memory components, embedded controllers, modules, additional network interfaces, etc.). Further, the embodiments described herein with respect to computer system 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

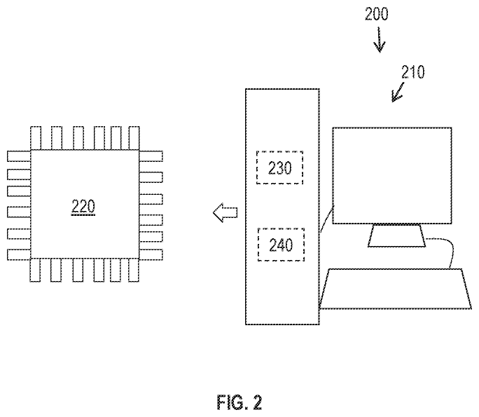

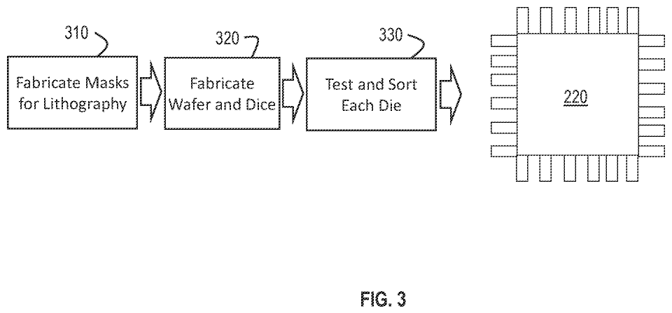

FIG. 2 is a block diagram of a system 200 configured to perform parasitic capacitance-aware dummy metal fill methodologies according to embodiments of the invention. The system 200 includes processing circuitry 210 used to generate the design that is ultimately fabricated into an integrated circuit 220. The steps involved in the fabrication of the integrated circuit 220 are well-known and briefly described herein. Once the physical layout is finalized, based, in part, on trimming one or more dummy metal shapes in one or more capacitive sensitive layers of the layout, to facilitate optimization of the placing and routing plan, the finalized physical layout is provided to a foundry. Masks are generated for each layer of the integrated circuit based on the finalized physical layout. Then, the wafer is processed in the sequence of the mask order. The processing includes photolithography and etch. This is further discussed with reference to FIG. 3.

FIG. 3 is a process flow of a method of fabricating an integrated circuit (e.g., the IC 220 of FIG. 2) according to exemplary embodiments. Once the physical design data is obtained, based, in part, on capacitance-aware dummy metal fill methodologies, the integrated circuit 220 can be fabricated according to known processes that are generally described with reference to FIG. 3. Generally, a wafer with multiple copies of the final design is fabricated and cut (i.e., diced) such that each die is one copy of the integrated circuit 220. At block 310, the processes include fabricating masks for lithography based on the finalized physical layout. At block 320, fabricating the wafer includes using the masks to perform photolithography and etching. Once the wafer is diced, testing and sorting each die is performed, at block 330, to filter out any faulty die.

FIG. 4 is a block diagram representing a method of creating a physical layout of a circuit design in a manner that reduces interlayer parasitic capacitance in accordance with one or more embodiments. The process generally begins at Step 402, where a plurality of logic and power cells (representing, e.g., power rails and pins, lines, vias, etc.) are placed and routed across a plurality of design layers. Step 402 is commonly referred to as place and route, or PnR. Once PnR is complete, initial dummy fill shapes (so-called dummy metals, metal fills, etc.) are distributed across the layers at Step 404 to ensure manufacturability and reliability (e.g., to satisfy predetermined density requirements). In some embodiments, Step 404 is carried out without regard to interlayer parasitic capacitance effects.

At Step 406, parasitics are extracted (sometimes referred to as RC extraction) and an initial timing analysis is completed (sometimes referred to as clock-tree synthesis and optimization, net timing, or simply, timing). RC extraction and timing calculations can be completed using known and commercially available methodologies, such as, for example, software having 3D capacitance random-walk field solvers and separate or integrated timing convergence.

At Step 408, one or more parasitic capacitance-sensitive layers are selected. The selection of capacitive-sensitive layers can be based on, for example, empirical or modeled interlayer capacitance effects. Empirical or modeled interlayer capacitance effects can be determined based on the respective metal and via specifications (e.g., materials, critical dimensions, aspect ratios, etc.), dielectric specifications (e.g., materials used, such as high-k or low-k dielectrics, thickness, etc.), and other design specifications (e.g., Mₓ layer thicknesses). In some embodiments of the invention, the selection of capacitive-sensitive layers is based on a list of known sensitive layers from prior empirical data or simulations. In some embodiments of the invention, the selection of capacitive-sensitive layers is based on technology and/or design definitions (e.g., all layers at or below M a). In some embodiments, the selection of capacitive-sensitive layers is based on the parasitics results from Step 406. For example, one or more hot regions and/or layers of dummy metals can be selected. As used herein, a “hot” region can be defined as any region having relatively high parasitics (i.e., as measured against a predetermined threshold and/or as measured relatively against the other layers, e.g., the N layers having highest parasitics, etc.).

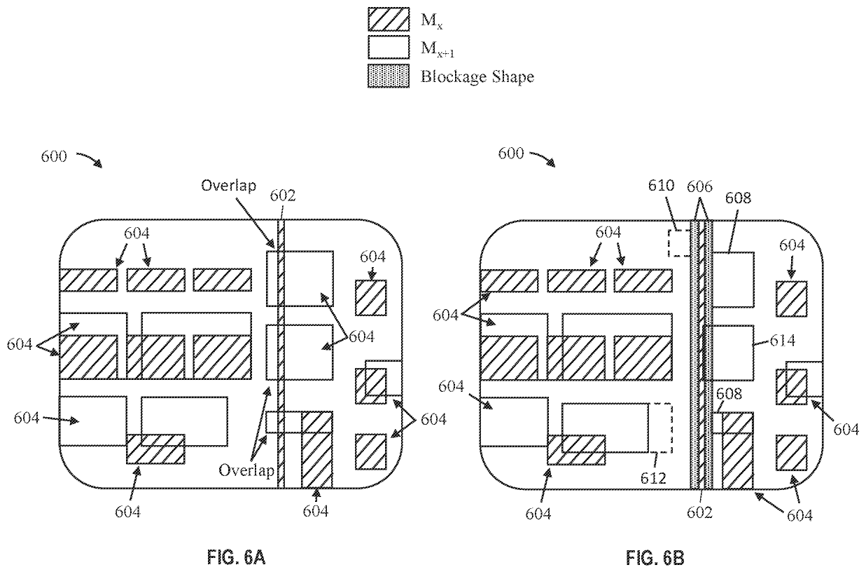

At Step 410, one or more dummy metal shapes are adjusted (e.g., trimmed and/or moved) to reduce interlayer parasitic capacitance. Dummy metal shape trimming is discussed in greater detail with respect to FIG. 6, but generally involves reducing the footprint of a dummy shape to mitigate or eliminate a vertical overlap between the dummy shape (e.g., at some layer Mₓ) and a metal shape above and/or below the dummy shape (e.g., in layers Mₓ₋₁ and/or Mₓ₊₁).

At Step 412, the layout undergoes design rule checking (DRC) analysis. DRC analysis is well-known and can be completed using known or available DRC software, including integrated solutions, etc. In some embodiments, DRC analysis includes density checks for each respective layer of the layout. In some embodiments, trimming and/or moving one or more dummy fill shapes (i.e., as in Step 410) results in one or more density failures during Step 412.

In some embodiments, DRC check failures (DRC Check “F” at Step 412) proceed to Step 414, where one or more adjusted dummy metal shapes are readjusted to increase density. In some embodiments, one or more trimmed dummy metal shapes are adjusted by reducing the degree of trimming. In some embodiments, one or more adjusted dummy metal shapes are readjusted by changing the size, shape, and/or location of the respective dummy metal shape. For example, a dummy metal shape can be extended in a direction of non-overlap with shapes above/below. In this manner, density requirements can be satisfied without reducing parasitic capacitance reductions. In some embodiments, if density requirements cannot be satisfied after initial adjustments (i.e., a first pass trimming, reshaping, moving, etc.), the dummy shapes can be incrementally adjusted (in one or more of size, shape, location, etc.) until DRC analysis passes (DRC Check “P” at Step 412). In this manner, even if complete elimination of overlap between a dummy metal shape and a shape above/below is not possible, the maximum degree of parasitic reduction (in view of the design constraints) can be achieved.

Once DRC analysis passes at Step 412, the layout undergoes Sign-off and timing checks at Step 416. Sign-off and timing checks are well-known and can be completed using known or available tools. Advantageously, the proposed flow has great advantage in timing closure as large timing discrepancies caused by interlayer parasitic capacitance are largely mitigated. If the Sign-off fails (“F” at Step 416), the layout design can pass back to Step 414. In some embodiments of the invention, DRC (Step 412), Sign-off and timing (Step 416), and dummy shape adjustments (Step 414) are iterated until timing is closed. In some embodiments, a predetermined threshold number of iterations for timing closure is allowed. In some embodiments, failure to close timing by the predetermined threshold number of iterations results in iterating from Step 408 rather than Step 414 (not separately shown in FIG. 4). In other words, a different subset of layers can be selected for parasitic capacitance reduction and the process can be repeated (i.e., Step 408 to Step 418) until timing is closed. Moreover, observe that at the point reached in Step 406, timing closure is calculated conventionally (e.g., conventional PnR timing closure tuning). During or after Step 414, however, PnR timing closure tuning occurs iteratively in response to dummy metal shape adjustments (e.g., trimming, moving, reshaping, etc.).

Once Sign-off and timing passes (“P” at Step 416), the layout design can pass to Step 418. In some embodiments, the approved, final layout (Step 418) is used to fabricate an integrated circuit as discussed, e.g., in FIGS. 2 and 3.

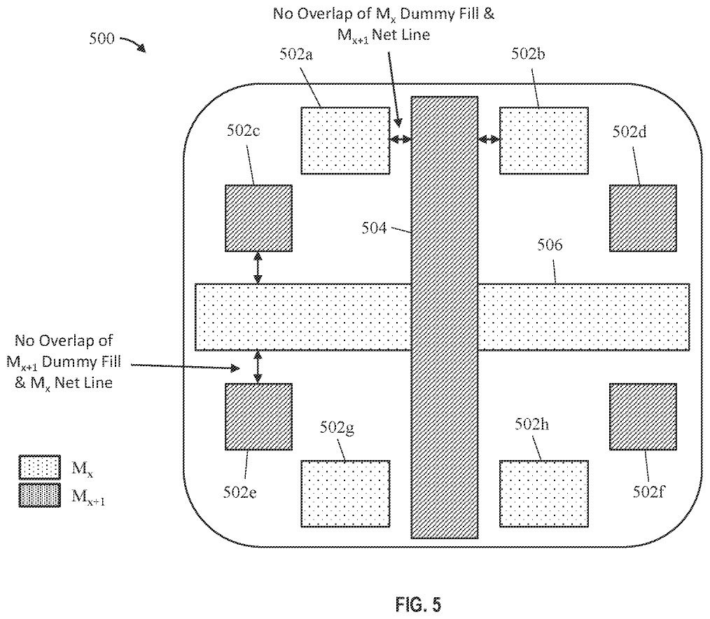

FIG. 5 depicts a design layout 500 having a reduced interlayer parasitic capacitance in accordance with one or more embodiments of the present invention. As shown in FIG. 5, the design layout 500 can include a plurality of dummy fill shapes 502a, 502b, 502c, 502d, 502e, 502f, 502g, 502h, etc. (collectively, the dummy shapes 502). In some embodiments, the dummy shapes 502 can be distributed arbitrarily across two or more layers (e.g., layer Mₓ and layer Mₓ₊₁) of the design layout 500 as needed for the respective design. The design layout 500 can further include one or more metal shapes (power cells, logic cells, lines, vias, etc.; as shown, a first net line 504 on layer Mₓ₊₁ and a second net line 506 on layer Mₓ). The number and exact placement of the dummy shapes 502 and/or the metal shapes/cells is provided solely for ease of illustration and is not meant to be particularly limited.

As further shown in FIG. 5, the dummy shapes 502 have been trimmed or moved according to one or more embodiments such that no vertical overlap exists between a dummy shape and a metal shape from the layer above or below the dummy shape. For example, the dummy fill shape 502a has been trimmed back from the first net line 504 while the dummy fill shape 502e has been trimmed back from the second net line 506.

FIG. 6A depicts a design layout 600 prior to dummy shape adjustments in accordance with one or more embodiments of the present invention. As shown in FIG. 6A, the design layout 600 can include a plurality of metal shapes (here, a single clock net 602, but could include, e.g., any number of a clock nets, vias, lines, etc.) and a plurality of dummy fill shapes 604 (here, all remaining shapes) distributed across layers Mₓ and Mₓ₊₁ of the design layout 600.

As further shown in FIG. 6A, three of the dummy fill shapes 604 on the upper layer (i.e., layer Mₓ₊₁) overlap the clock net 602. As discussed previously, metal-dummy metal overlaps lead to parasitic capacitance, reducing device performance.

FIG. 6B depicts the design layout 600 after making dummy shape adjustments in accordance with one or more embodiments of the present invention. As shown in FIG. 6B, a blockage shape 606 is formed around the clock net 602. While shown having a particular shape of ease of discussion, the dimensions of the blockage shape 606 are not meant to be particularly limited. In some embodiments, the size, boundaries, and/or number of blockage shapes can vary as needed to accommodate the DRC and sign-off requirements of a respective layout (as discussed, e.g., with respect to FIG. 4).

As further shown in FIG. 6B, some of the dummy fill shapes 604 have been trimmed (now labeled as trimmed shapes 608) to avoid overlapping the blockage shape 606. In other words, metal fills on the upper layer (Mₓ₊₁) can be trimmed to respect one or more blockage shapes in the lower layer (Mₓ), or vice versa.

As discussed previously, trimming one or more of the dummy fill shapes 604 can result in DRC or sign-off errors. For example, trimming the trimmed shapes 608 can result in a low-density failure(s) near the blockage shape 606. In some embodiments, an iterative process is used to progressively modify the size, orientation, boundaries, number, etc. of the dummy fill shapes 604 until DRC and sign-off can be satisfied. For example, new dummy fill shapes (here, dummy fill shape 610) can be added to the design layout 600 to increase density near the blockage shape 606. In another example, one or more existing dummy fill shapes 604 can be moved or extended (here, moved shape 612) to increase density near the blockage shape 606. In yet another example, one of more of the trimmed shapes 608 can be wholly or partially reverted (that is, the degree of the respective trim and/or other adjustment can be reduced), resulting in a wholly or partially trimmed shape 614.

As discussed previously, adjusting one or more of the dummy fill shapes 604 to the extent possible under DRC and sign-off constraints results in an overall reduction in parasitic capacitance. Such modifications provide a variety of benefits in the final device, such as, for example, improved power efficiency.

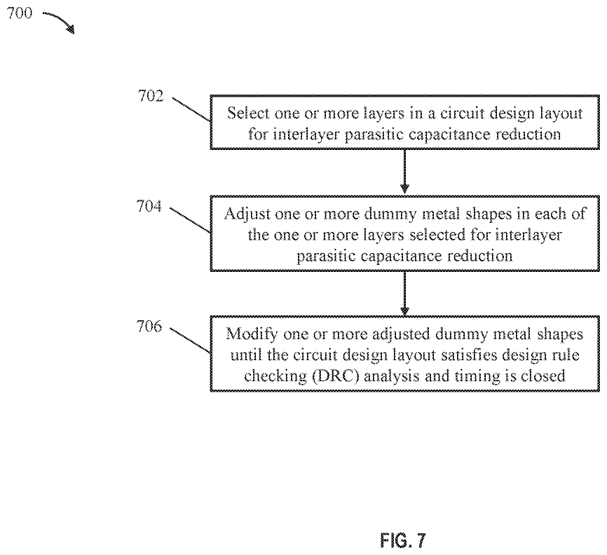

Referring now to FIG. 7, a flowchart 700 for determining a layout design using a parasitic capacitance-aware dummy metal fill methodology in accordance with one or more embodiments is generally shown. The flowchart 700 is described in reference to FIGS. 1-6B and may include additional blocks not depicted in FIG. 7. Although depicted in a particular order, the blocks depicted in FIG. 7 can be rearranged, subdivided, and/or combined. In accordance with one or more embodiments of the present invention, the computer system 100 of FIG. 1 is utilized to perform at least a portion of the processing described with reference to FIG. 7.

At block 702, one or more layers in a circuit design layout are selected for interlayer parasitic capacitance reduction. In some embodiments, selecting the one or more layers includes selecting a subset of the one or more layers having a relatively highest sensitivity to parasitic capacitance. In some embodiments, selecting the one or more layers is based on one or both of empirical and modeled interlayer capacitance effects. In some embodiments, selecting the one or more layers is based on a list of predetermined parasitic-capacitance sensitive layers.

At block 704, one or more dummy metal shapes in each of the one or more layers selected for interlayer parasitic capacitance reduction are adjusted. In some embodiments, adjusting a dummy metal shape includes moving, reshaping, adding, deleting, and/or trimming the respective dummy metal shape. In some embodiments, adjusting one or more dummy metal shapes includes trimming to reduce a footprint of each respective dummy metal shape to decrease a vertical overlap between the respective dummy metal shape and a metal shape above or below the respective dummy metal shape.

At block 706, one or more adjusted dummy metal shapes are modified until the circuit design layout satisfies design rule checking (DRC) analysis and timing is closed. In some embodiments, one or more blockage shapes are formed around the metal shape above or below the respective dummy metal shape. In some embodiments, modifying one or more adjusted dummy metal shapes includes at least one of adding a new dummy metal shape to increase density near the blockage shape, extending an existing dummy metal shape to increase density near the blockage shape, and reducing a degree of trim of one of the dummy metal shapes.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 8, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described herein above, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 8 are intended to be illustrative only and that computing nodes 10 and cloud computing environment 50 can communicate with any type of computerized device over any type of network and/or network addressable connection (e.g., using a web browser).

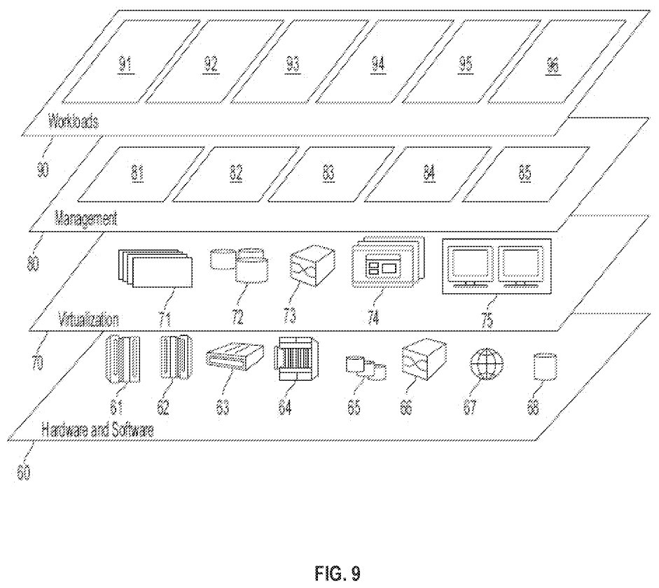

Referring now to FIG. 9, a set of functional abstraction layers provided by cloud computing environment 50 (FIG. 8) is shown. It should be understood in advance that the components, layers, and functions shown in FIG. 9 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and software applications 96 (e.g., software 111 of FIG. 1), etc. Also, software applications can function with and/or be integrated with Resource provisioning 81.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
selecting one or more layers in a circuit design layout for interlayer parasitic capacitance reduction;
adjusting one or more dummy metal shapes in each of the one or more layers selected for interlayer parasitic capacitance reduction; and
modifying one or more adjusted dummy metal shapes until the circuit design layout satisfies design rule checking (DRC) analysis and timing is closed.

2. The computer-implemented method of claim 1, wherein selecting the one or more layers comprises selecting a subset of the one or more layers having a relatively highest sensitivity to parasitic capacitance.

3. The computer-implemented method of claim 1, wherein selecting the one or more layers is based on one or both of empirical and modeled interlayer capacitance effects.

4. The computer-implemented method of claim 1, wherein selecting the one or more layers is based on a list of predetermined parasitic-capacitance sensitive layers.

5. The computer-implemented method of claim 1, wherein adjusting one or more dummy metal shapes comprises trimming to reduce a footprint of each respective dummy metal shape to decrease a vertical overlap between the respective dummy metal shape and a metal shape above or below the respective dummy metal shape.

6. The computer-implemented method of claim 5, further comprising forming one or more blockage shapes around the metal shape above or below the respective dummy metal shape.

7. The computer-implemented method of claim 6, wherein modifying one or more adjusted dummy metal shapes comprises at least one of adding a new dummy metal shape to increase density near the blockage shape, extending an existing dummy metal shape to increase density near the blockage shape, and reducing a degree of trim of one of the dummy metal shapes.

8. A system comprising a memory having computer readable instructions and one or more processors for executing the computer readable instructions, the computer readable instructions controlling the one or more processors to perform operations comprising:
selecting one or more layers in a circuit design layout for interlayer parasitic capacitance reduction;
adjusting one or more dummy metal shapes in each of the one or more layers selected for interlayer parasitic capacitance reduction; and
modifying one or more adjusted dummy metal shapes until the circuit design layout satisfies design rule checking (DRC) analysis and timing is closed.

9. The system of claim 8, wherein selecting the one or more layers comprises selecting a subset of the one or more layers having a relatively highest sensitivity to parasitic capacitance.

10. The system of claim 8, wherein selecting the one or more layers is based on one or both of empirical and modeled interlayer capacitance effects.

11. The system of claim 8, wherein selecting the one or more layers is based on a list of predetermined parasitic-capacitance sensitive layers.

12. The system of claim 8, wherein adjusting one or more dummy metal shapes comprises trimming to reduce a footprint of each respective dummy metal shape to decrease a vertical overlap between the respective dummy metal shape and a metal shape above or below the respective dummy metal shape.

13. The system of claim 12, further comprising forming one or more blockage shapes around the metal shape above or below the respective dummy metal shape.

14. The system of claim 13, wherein modifying one or more adjusted dummy metal shapes comprises at least one of adding a new dummy metal shape to increase density near the blockage shape, extending an existing dummy metal shape to increase density near the blockage shape, and reducing a degree of trim of one of the dummy metal shapes.

15. A computer program product comprising a computer readable storage medium having program instructions embodied therewith, the program instructions executable by one or more processors to cause the one or more processors to perform operations comprising:
selecting one or more layers in a circuit design layout for interlayer parasitic capacitance reduction;
adjusting one or more dummy metal shapes in each of the one or more layers selected for interlayer parasitic capacitance reduction; and
modifying one or more adjusted dummy metal shapes until the circuit design layout satisfies design rule checking (DRC) analysis and timing is closed.

16. The computer program product of claim 15, wherein selecting the one or more layers comprises selecting a subset of the one or more layers having a relatively highest sensitivity to parasitic capacitance.

17. The computer program product of claim 15, wherein selecting the one or more layers is based on one or both of empirical and modeled interlayer capacitance effects.

18. The computer program product of claim 15, wherein selecting the one or more layers is based on a list of predetermined parasitic-capacitance sensitive layers.

19. The computer program product of claim 15, wherein adjusting one or more dummy metal shapes comprises trimming to reduce a footprint of each respective dummy metal shape to decrease a vertical overlap between the respective dummy metal shape and a metal shape above or below the respective dummy metal shape.

20. The computer program product of claim 19, further comprising forming one or more blockage shapes around the metal shape above or below the respective dummy metal shape.
